(19) United States
(12) Patent Application Publication
(10) Pub. No.: US 2025/0334164 A1
(43) Pub. Date: Oct. 30, 2025

(54) SOLAR TRACKER DAMPER SIGHT GAUGE

(71) Applicant: Nextracker LLC, Fremont, CA (US)

(72) Inventors: David Kresse, Walnut Creek, CA (US); Raghavendra Praveen Maddulapalli, Vijayawada (IN)

(21) Appl. No.: 18/649,420

(22) Filed: Apr. 29, 2024

(51) Int. Cl. F16F 9/32; H02S 20/32

(52) U.S. Cl. CPC F16F 9/3264; H02S 20/32; F16F 2230/0047

(57) ABSTRACT

A method for inspecting an oil volume at a damper assembly at a solar tracker includes rotating a torque tube of the solar tracker from a first rotational position to a predefined rotational position, that is different than the first rotational position, to reveal an oil sight gauge at the damper assembly. This method also includes, when the torque tube is at the predefined rotational position and the oil sight gauge is revealed, inspecting an oil volume within the damper assembly using the oil sight gauge.

### TECHNICAL FIELD

This disclosure is generally directed to device, system, and method embodiments relating to damper assemblies for solar trackers. Solar tracker damper assembly embodiments and related method embodiments disclosed herein can be configured to facilitate more efficient inspection of damper assemblies, such as more efficient inspection of damper assemblies while the damper assemblies are coupled to the solar tracker.

### BACKGROUND

Solar modules can convert sunlight into energy using photovoltaic cells. Solar tracking systems can support a plurality of solar modules and function to rotate these solar modules amongst a variety of different angular orientations throughout a given day to optimize a solar irradiance angle and, thereby, optimize energy generation at the solar modules.

Solar trackers can be installed at a variety of field locations. The installed solar tracker will typically experience dynamic loads throughout its operational life, including dynamic loads, such as wind loads, resulting from environmental conditions at the solar tracker site. Wind loading, for instance from the east or west, can cause the solar tracker (e.g., torque tube) to oscillate or twist back and forth. This wind loading and resulting solar tracker oscillation can be particularly acute when the solar tracker is at certain rotational positions, such as within roughly twenty degrees of horizontal. In cases of high winds, the range of oscillation may increase to a level resulting in permanent damage to the solar tracker and accompanying solar modules.

### SUMMARY

This disclosure in generally directed to device, system, and method embodiments relating to damper assemblies for solar trackers. A damper assembly can be installed at a solar tracker to help absorb energy resulting from dynamic loading applied to the solar tracker in the field, such as to help absorb energy resulting from wind loads applied to the solar tracker in the field. As such, the damper assembly can help to reduce or prevent oscillation of the solar tracker due to wind loads and thereby help to increase the long-term useful life of the solar tracker. However, for the damper assembly to properly serve this intended function, the damper assembly needs to be inspected and maintained in an operational condition that is suitable to absorb and dampen these loads. One type of damper assembly inspection is assessing an oil volume present within the damper assembly and maintaining the oil volume within the damper assembly at an operational damper oil volume.

Damper assembly embodiments disclosed herein can be configured to facilitate efficient damper inspection and maintenance, for instance, while the damper assembly remains installed at the solar tracker in the field. This can provide useful advantages over other means for inspecting and maintaining a solar tracker damper assembly which typically necessitate removing the damper assembly from the solar tracker and inspecting the damper assembly at a different location remote from the solar tracker.

Various embodiments disclosed herein include a damper assembly that includes an oil sight gauge. Because the oil level inside a damper assembly can change as a function of the stroke position of the damper assembly throughout a range of movement of the solar tracker over a given day, there may not be a static damper assembly position where the oil level will always be. On the other hand, if damper oil volume inspections are routinely performed when the solar tracker is set to a predefined tilt position (e.g., sixty degree stow position of the torque tube), including an oil sight gauge at the damper assembly can provide a visual indication corresponding to the oil level within the damper assembly at this particular predefined tilt position of the solar tracker and thus corresponding to the particular damper assembly stroke position at that predefined tilt position of the solar tracker. As such, embodiments disclosed herein can be useful in providing a common relative baseline from which to inspect damper oil volume using the oil sight gauge and can do so while the damper assembly remains installed at the solar tracker.

One embodiment includes a damper assembly. This damper assembly embodiment includes an upper damper mount, a lower damper mount, and at least one strut. The upper damper mount is configured to operably couple to a torque tube of a solar tracker. The lower damper mount is configured to operably couple to a pier of the solar tracker. The strut is configured to operably couple to the upper damper mount at a first end portion of the strut and to operably couple to the lower damper mount at a second, opposite end portion of the strut such that rotation of the upper damper mount effectuates a compression or an extension of the strut between the upper damper mount and the lower damper mount. The strut includes an oil sight gauge located at a position along the strut such that the oil sight gauge is covered when the upper damper mount is at a first rotational position and uncovered when the upper damper mount is at a second, different rotational position.

In a further embodiment of this damper assembly, the damper assembly is configured for use with a solar tracker such that the upper damper mount is configured to operably couple to a torque tube of the solar tracker and the lower damper mount is configured to operably couple to a pier of the solar tracker. The oil sight gauge can be located at a position along the strut such that the oil sight gauge is covered when the torque tube is at a first rotational position and uncovered when the torque tube is at a second, different rotational position. For instance, the second, different rotational position can be a predefined rotational tilt position of the torque tube such that when the torque tube is at the predefined rotational tilt position the oil sight gauge is uncovered. The first rotational position can be selected from group consisting of torque tube rotational tilt positions outside of the predefined rotational tilt position of the torque tube such that when the torque tube is at the torque tube rotational tilt positions outside of the predefined rotational tilt position the oil sight gauge is covered. As one example, the predefined rotational tilt position of the torque tube can be a sixty degree stowed rotational position of the torque tube.

In a further embodiment of this damper assembly, the oil sight gauge can include a transparent material at the strut. In one such example, the oil sight gauge can additionally include one or more oil level indicator markings adjacent to the transparent material.

In a further embodiment of this damper assembly, the strut includes an inner strut tube and an outer strut tube, with the outer strut tube being movable relative to the inner strut tube. The oil sight gauge is located at a position along the inner strut tube such that the oil sight gauge is covered by the outer strut tube when the upper damper mount is at the first rotational position, and the oil sight gauge is located at a position along the inner strut tube such that the oil sight gauge is uncovered by the outer strut tube when the upper damper mount is at the second, different rotational position. For example, when the oil volume within the damper assembly is at an operational damper oil volume, the oil sight gauge can be configured at the damper assembly such that the second rotational position of the upper damper mount corresponds to visibility of the operational damper oil volume within the damper assembly through the oil sight gauge. And when the oil level within the damper assembly is less than the operational damper oil volume, the oil sight gauge can be configured at the damper assembly such that the second rotational position of the upper damper mount corresponds to a lack of visibility of the less than operational damper oil volume within the damper assembly through the oil sight gauge.

In a further embodiment of this damper assembly, the strut can further include a strut rod that is coupled to the outer strut tube. The strut rod can be configured to operably couple to the upper damper mount at the first end portion of the strut. The strut rod can be configured such that rotation of the upper damper mount from the first rotational position to the second, different rotational position causes the strut rod to move the outer strut tube relative to the inner strut tube to thereby uncover the oil sight gauge at the inner strut tube.

Another embodiment includes a method for inspecting an oil volume at a damper assembly at a solar tracker. This method embodiment includes the steps of: rotating a torque tube of the solar tracker from a first rotational position to a predefined rotational position, that is different than the first rotational position, to reveal an oil sight gauge at the damper assembly; and when the torque tube is at the predefined rotational position and the oil sight gauge is revealed, inspecting an oil volume within the damper assembly using the oil sight gauge.

In a further embodiment of this method, when the torque tube is at the first rotational position the oil sight gauge is covered, and, when the torque tube is at the predefined rotational position the oil sight gauge is uncovered to reveal the oil sight gauge. In one such example, the damper assembly includes a strut that is operably coupled to the torque tube. The strut includes the oil sight gauge, and rotating the torque tube from the first rotational position to the predefined rotational position to reveal the oil sight gauge includes effectuating a compression or an extension of the strut to uncover the oil sight gauge. For instance, when the torque tube is at the first rotational position a strut rod of the strut can be extended out from the damper assembly a first distance that causes the oil sight gauge to be covered, and when the torque tube is at the predefined rotational position the strut rod can be extended out from the damper assembly a second distance, that is different than the first distance, that causes the oil sight gauge to be revealed and uncovered. In some such examples, the strut can further include an inner strut tube and an outer strut tube, with the outer strut tube being movable relative to the inner strut tube via the strut rod and the oil sight gauge located at the inner strut tube. When the torque tube is at the first rotational position the oil sight gauge is covered by the outer strut tube, and when the torque tube is at the predefined rotational position the oil sight gauge is uncovered by the outer strut tube.

In a further embodiment of this method, the predefined rotational position of the torque tube can correspond to a stowed solar tracker orientation.

In a further embodiment of this method, the predefined rotational position of the torque tube can be a sixty degrees stowed position, and the first rotational position of the torque tube can be any other rotational position of the torque tube ranging from zero degrees to less than sixty degrees.

In a further embodiment of this method, inspecting the oil volume within the damper assembly using the oil sight gauge can include determining that the damper assembly does not need maintenance when oil is visible through the oil sight gauge while the torque tube is at the predefined rotational position and the oil sight gauge is revealed. And, in a further such embodiment, inspecting the oil volume within the damper assembly using the oil sight gauge can include determining that the damper assembly needs maintenance when oil is not visible through the oil sight gauge while the torque tube is at the predefined rotational position and the oil sight gauge is revealed.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular examples of the present invention and therefore do not limit the scope of the invention. The drawings are intended for use in conjunction with the explanations in the following detailed description wherein like reference characters denote like elements. Examples of the present invention will hereinafter be described in conjunction with the appended drawings.

FIG. 1 is an elevational view of an embodiment of a solar tracker apparatus.

FIGS. 2A and 2B illustrate elevational views of an embodiment of a damper assembly at a pier of a solar tracker apparatus. FIG. 2A shows the damper assembly at a first rotational position at which an oil sight gauge is covered, and FIG. 2B shows the damper assembly at a second, different rotational position at which an oil sight gauge is uncovered.

FIGS. 3A and 3B illustrate elevational views of an embodiment of a strut of the damper assembly of FIGS. 2A-2B. FIG. 3A shows an oil sight gauge at the strut covered by a tube of the strut, and FIG. 3B shows the oil sight gauge at the strut uncovered by the tube of the strut.

FIG. 4 is an elevational view of another embodiment of a strut with an oil sight gauge.

FIG. 5 is a flow diagram of an embodiment of a method for inspecting an oil volume at a damper assembly at a solar tracker apparatus.

### DETAILED DESCRIPTION

The following detailed description is exemplary in nature and is not intended to limit the scope, applicability, or configuration of the invention in any way. Rather, the following description provides some practical illustrations for implementing examples of the present invention. Those skilled in the art will recognize that many of the noted examples have a variety of suitable alternatives.

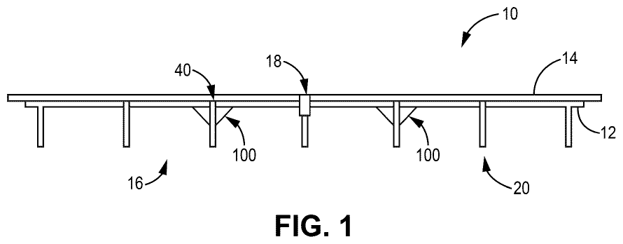

FIG. 1 illustrates an embodiment of a solar tracker apparatus 10. The solar tracker apparatus 10 can include a plurality of piers 20 disposed in spaced relation to one another and embedded in the earth. A torque tube 12 can extend between adjacent piers 20, and the torque tube 12 can be rotatably supported on each pier 20 such that the torque tube 12 can rotate relative to the piers 20. The solar tracker 10 can also include a plurality of solar panels 14 supported on the torque tube 12, and the solar panels 14 can include photovoltaic cells that are configured to convert sunlight into electrical energy. The span between two adjacent piers 20 can be referred to as a bay 16 (e.g., which can in the range of about 8 meters in length). The illustrated embodiment shows a row formed by the solar tracker 10, and the row can be arranged in a north-south longitudinal orientation. In many applications, a plurality of rows can be included, spaced apart from one another, and each arranged in a north-south longitudinal orientation to collectively form a solar array at the solar tracker.

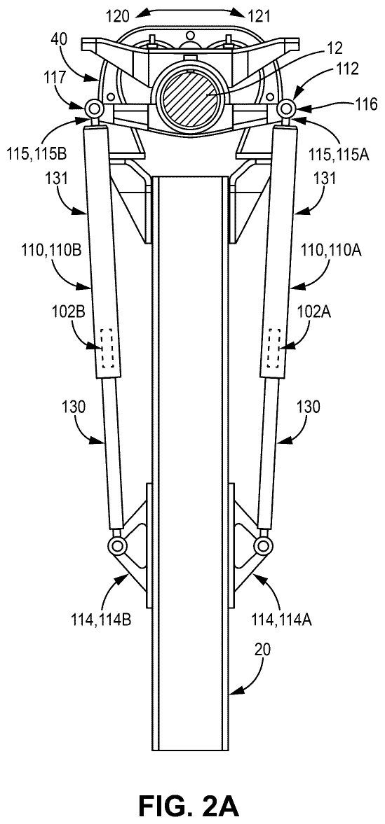

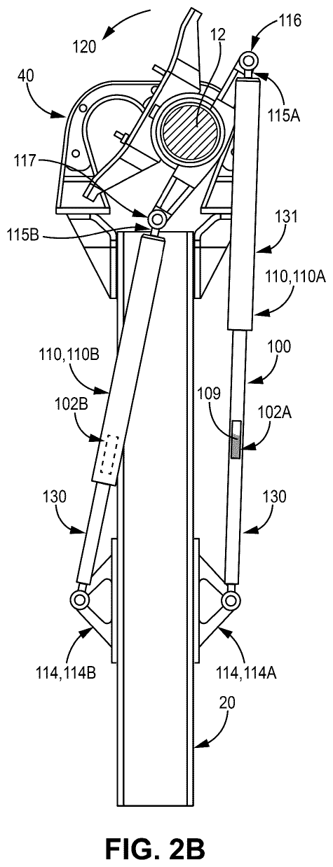

As noted, the torque tube 12 can rotate, which thereby rotates the solar panels 14. In particular, the torque tube 12 can be rotated throughout a given day to track the position of the sun and thereby better optimize the angle between the sun and the solar panels 14 throughout the day. To facilitate rotation of the torque tube 12 between a variety of rotational positions, the solar tracker 10 can additionally include a motive source that is configured to impart rotational force on the torque tube. The illustrated embodiment shows the solar tracker 10 as including a drive mechanism (e.g., slew drive) 18 operably coupled to the torque tube 12 and supported on a respective pier of the plurality of piers 20. The drive mechanism 18 can effectuate rotation of the torque tube 12, which in turn can effectuate a corresponding rotation of the solar panels 14 to track the location of the sun. To further help accommodate rotation of the torque tube 12, the solar tracker 10 can include a plurality of bearing housing assemblies (BHA) 40 disposed on respective piers 20 of the plurality of piers 20. Each of the plurality of bearing housing assemblies 40 is operably coupled to the torque tube 12 to rotatably support the torque tube 12 therein (e.g., as shown at FIGS. 2A and 2B) as the torque tube 12 is caused to be rotated by the drive mechanism 18.

When installed in the field, the solar tracker 10 can be subjected to dynamic load, such as wind loads, resulting from environmental conditions at the solar tracker site. Wind loading, for instance from the east or west, can cause the solar tracker 10 (e.g., torque tube 12) to oscillate or twist back and forth. Depending on the magnitude of the dynamic load, the range of oscillation may increase to a level resulting in permanent damage to the solar tracker 10 and accompanying solar modules. To help absorb energy imparted at the solar tracker 10 by such dynamic loads, the solar tracker 10 can include one or more damper assemblies 100 which can help to reduce or prevent oscillation of the solar tracker 10 (e.g., oscillation of the torque tube 12) due to wind, or other environmental, loads and thereby help to increase the long-term useful life of the solar tracker 10.

To maintain the damper assembly 100 in operation condition so that it can serve its force absorbing and dampening function, the damper assembly 100 can include a lubricating fluid, such as oil, and the damper assembly 100 can be inspected to assess the presence of proper oil volume inside the damper assembly 100. However, because the oil level inside the damper assembly 100 can change as a function of the stroke position of the damper assembly 100 throughout a range of movement of the solar tracker over a given day, there may not be a static damper assembly position where the oil level will always be. To help solve for this variability and to provide a relative and more accurate oil volume inspection assessment, as will be described further herein, damper oil volume inspections can be performed when the solar tracker is set to a predefined tilt position (e.g., sixty degree stow position of the torque tube), In doing so, an oil sight gauge at the damper assembly 100 can provide a visual indication corresponding to the oil, or other lubricating fluid, level within the damper assembly 100 at this particular predefined tilt position of the solar tracker and thus corresponding to the particular damper assembly stroke position at that predefined tilt position of the solar tracker. As such, embodiments disclosed herein can be useful in providing a common relative baseline from which to inspect damper oil volume using the oil sight gauge and can do so while the damper assembly remains installed at the solar tracker.

FIGS. 2A and 2B illustrate an embodiment of damper assembly 100 at pier 20 of solar tracker 10. In particular, FIG. 2A shows the damper assembly 100 at a first rotational position at which an oil sight gauge 102A is covered, and FIG. 2B shows the damper assembly 100 at a second, different rotational position at which the oil sight gauge 102A is uncovered.

The damper assembly 100 can include a pair of struts 110, an upper damper mount 112 that is configured to operably couple to torque tube 12, and a pair of lower damper mounts 114 that are each configured to operably couple to pier 20. The pair of struts can include first strut 110A and second strut 110B, and the pair of lower damper mounts 114 can include first lower damper mount 114A and second lower damper mount 114B. The upper damper mount 112 can include a pair of wings 116, 117 disposed in spaced relation to one another at opposite side portions of the upper damper mount 112. The first strut 110A can couple to the upper damper mount 112 at one end and couple to the first lower damper mount 114A at a second opposite end. Similarly, the second strut 110B can couple to the upper damper mount 112 at one end and couple to the second lower damper mount 114B at a second opposite end. More specifically, as shown for the illustrated embodiment, the first strut 110A can include a first strut rod 115A coupled to the wing 116 at the upper damper mount 112 and the second strut 110B can include a second strut rod 115B coupled to the wing 117.

The pair of struts 110 may be any suitable strut capable of providing resistance to compression and/or damping linear movement thereof. In this manner, the pair of struts 110 is releasably coupled to the upper damper mount 112 at a first portion thereof and releasably coupled to the lower damper mount 114 at a second, opposite portion thereof. As the torque tube 12 rotates in either direction 120, 121, the upper damper mount 112 is likewise rotated with the torque tube 12 in either direction 120, 121, which causes one strut of the pair of struts 110 to compress against the lower damper mount 114 and the other strut of the pair of struts 110 to extend between the upper and lower damper mounts 112, 114. Thus, rotation of the torque tube 12, and thus rotation of the upper damper mount 112, can effectuate a compression of extension of each strut 110A, 110B between the upper and lower damper mounts 112, 114. For example, as seen at FIGS. 2A and 2B, the torque tube 12 can be rotated in the direction 120 which can cause the upper damper mount 112 to rotate in the direction 120 in turn casing the first strut 110A to extend between upper damper mount 112 and lower damper mount 11A and also causing the second strut 110B to compress against the lower damper mount 114B. In this manner, the pair of struts 110 can absorb dynamic loading (e.g., torque) placed upon the torque tube 12 as the solar panels are likewise rotated, which can help to prevent the torque tube 12 from rotating too quickly and can ease strain placed on the drive mechanism. It is envisioned that the pair of struts 110 can be any suitable strut or damper, such as a gas filled strut, an elastomer strut, spring loaded strut, amongst others.

As noted, one or both struts 110A, 110B can include an oil sight gauge 102. The illustrated embodiment shows a first oil sight gauge 102A included at first strut 110A and a second oil sight gauge 102B included at second strut 110B. The oil sight gauges 102A, 102B can be located at a position along the respective strut 110A, 110B such that the oil sight gauge 102A, 102B is covered when the upper damper mount 112 is at a first rotational position and uncovered when the upper damper 112 mount is at a second, different rotational position.

For the illustrated solar tracker application of the damper assembly 100, the damper assembly 100 is configured for use with the solar tracker 10 such that, with the upper damper mount 112 operably coupled to the torque tube 12 of the solar tracker 10 and the lower damper mount 114 operably coupled to pier 20, the oil sight gauge 102A, 102B is located at a position along the respective strut 110A, 110B such that the corresponding oil sight gauge 102A, 102B is covered when the torque tube 12 is at a first rotational position and uncovered when the torque tube 12 is at a second, different rotational position. For example, the torque tube 12 and upper damper mount 112 can be at a first rotational positional as shown at FIG. 2A, and the torque tube 12 and upper damper mount 112 can be rotated in the direction 120 to a second, different rotational position as shown at FIG. 2B. As illustrated, the oil sight gauges 102A, 102B can be located at a position along the respective strut 110A, 110B such that the oil sight gauge 102A, 102B is covered when the upper damper mount 112 is at a first rotational position shown at FIG. 2A and uncovered when the upper damper 112 mount is at a second, different rotational position shown at FIG. 2B.

To help facilitate visual inspection of lubricating fluid 109 volume (e.g., oil volume) within a given strut 110A, 110B, the second rotational position that uncovers the oil sight gauge 102A can be a predefined rotational tilt position of the torque tube 12. And thus, when the predefined, second rotational position of the torque tube 12 and upper damper mount 112 is present, the oil sight gauge 102A at strut 110A can be uncovered (e.g., uncovered by the strut 110A) and thereby visible for inspection while the strut 110A is maintained installed at the pier 20. Conversely, the first rotational that convers the oil sight gauge 102A can be selected from group consisting of torque tube 12 (and thus upper damper mount 112) rotational tilt positions outside of the predefined, second rotational tilt position of the torque tube 12. And thus, when the first rotational position of the torque tube 12 and upper damper mount 112 is present, the oil sight gauge 102A at strut 110A can be covered (e.g., uncovered by the strut 110A) and thereby may not be visible for inspection. As one example, shown art FIG. 2B, the predefined, second rotational tilt position of the torque tube 12 can be a sixty degree stowed rotational position of the torque tube 12. This sixty degree stowed rotational position of the torque tube 12 serving as the predefined, second rotational tilt position of the torque tube 12 can be a rotational position that the torque tube 12 is typically maintained out during a nighttime/non-tracking portion of a given day. Inspecting the oil volume at a given strut 110A, 110B using the respective oil sight gauge 102A, 102B when the torque tube 12, and thus upper damper mount 112, are at the predefined, second rotational position can be useful in providing a common strut reference orientation for more accurately assessing oil level volume within the given strut 110A, 110B.

The illustrated struts 110A, 110B can each include an inner strut tube 130, an outer strut tube 131, and strut rod 115. The strut rod 115 as shown for the illustrated embodiment can be coupled to the outer strut tube 131, and the outer strut tube 131 can be movable relative to the inner strut tube 130. The strut rod 115 can operably couple to the upper damper mount 112 at the first end portion of the strut 110A, 110B. The oil sight gauge 102A, 102B at the respective strut 110A, 110B can be included at the inner strut tube 130. In particular, the oil sight gauge 102A, 102B at the respective strut 110A, 110B can be located at a position along the inner strut tube 130 such that the respective oil sight gauge 102A, 102B is covered by the outer strut tube 131 when the upper damper mount 112 is at the first rotational position, such as shown at FIG. 2A. In addition, the oil sight gauge 102A can be located at a position along the inner strut tube 130 of first strut 110A such that the oil sight gauge 102A is uncovered by the outer strut tube 131 when the upper damper mount 112 is at the second, different rotational position, such as shown at FIG. 2B (e.g., predefined +sixty degree stowed position in the direction 120). The strut rod 115 can be configured such that rotation of the upper damper mount 112 from the first rotational position at FIG. 2A to the second, different rotational position at FIG. 2B causes the strut rod 115 to move the outer strut tube 131 relative to the inner strut tube 130 to thereby uncover the oil sight gauge 102A at the inner strut tube 130. Similarly, the oil sight gauge 102B can be located at a position along the inner strut tube 130 of second strut 110B such that the oil sight gauge 102B is uncovered by the outer strut tube 131 when the upper damper mount 112 is at an inverse of the second, different rotational position (e.g., predefined-sixty degree stowed position in the direction 121).

This can allow the torque tube 12 to be controlled to rotate to the predefined rotational position to uncover the oil sight gauge 102A or 102B for oil volume inspection at a common, reference orientation of the strut 110A or 110B corresponding to the predefined rotational position of the torque tube 12 and upper damper mount 112. For instance, when the oil volume within the damper assembly 100 is at an operational damper oil volume, the oil sight gauge 102A and/or 102B can be configured at the strut 110A and/or 110B of the damper assembly 100 such that the second, predefined rotational position of the torque tube 12 and the upper damper mount 112 corresponds to visibility of the operational damper oil 109 volume within the damper assembly 100 through the oil sight gauge 102A and/or 102B. On the other hand, when the oil level within the damper assembly 100 is less than the operational damper oil volume, the oil sight gauge 102A and/or 102B can be configured at the strut 110A and/or 110B of the damper assembly 100 such that the second, predefined rotational position of the torque tube 12 and the upper damper mount 112 corresponds to a lack of visibility of the less than operational damper oil volume within the damper assembly 100 through the oil sight gauge 102A and/or 102B.

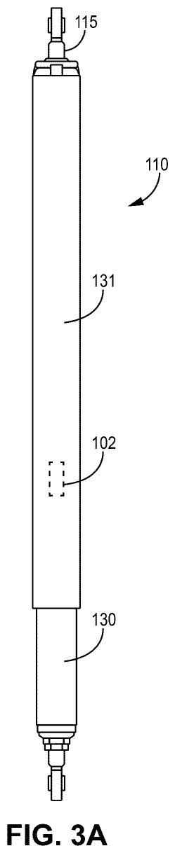

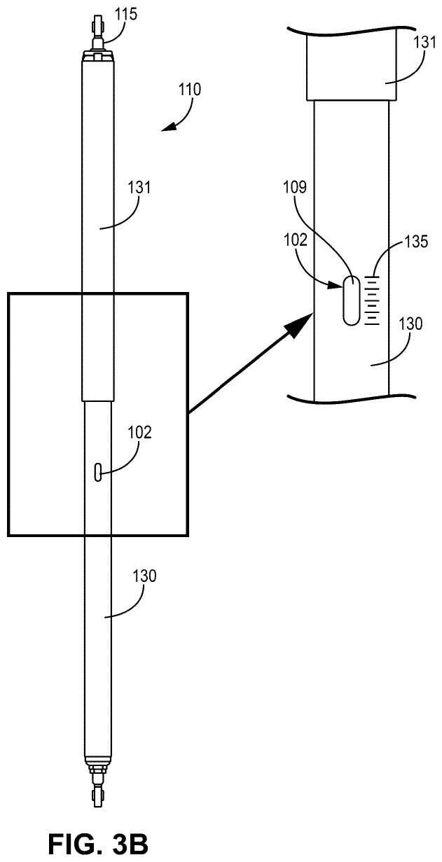

FIGS. 3A and 3B show an elevational view of the strut 110 in isolation. FIG. 3A shows oil sight gauge 102 at the strut 110 covered by the strut 110, while FIG. 3B shows oil sight gauge 102 at the strut 110 uncovered by the strut 110. Specifically, the illustrated embodiment here at FIG. 3A shows oil sight gauge 102 included at inner strut tube 130 and covered by outer strut tube 131, and the illustrated embodiment here at FIG. 3B shows oil sight gauge 102 included at inner strut tube 130 and uncovered by outer strut tube 131. As shown for the embodiment here, the oil sight gauge 102 can include a transparent material at the inner strut tube 130. The transparent material at the oil sight gauge 102 can allow for visually discerning the presence of oil, or other lubricating fluid, 109 within the strut 110. In addition, the strut 110 shown for the embodiment illustrated here has the oil sight gauge 102 as further including one or more oil level indicator markings 135. The one or more oil level indicator markings 135 can be included at the inner strut tube 130, such as adjacent to the transparent material of the oil sight gauge 102 at the inner strut tube 130. As previously described, the oil sight gauge 102, and when so included the one or more oil level indicator markings 135, can be revealed when the torque tube and upper damper mount are moved to a predefined rotational position.

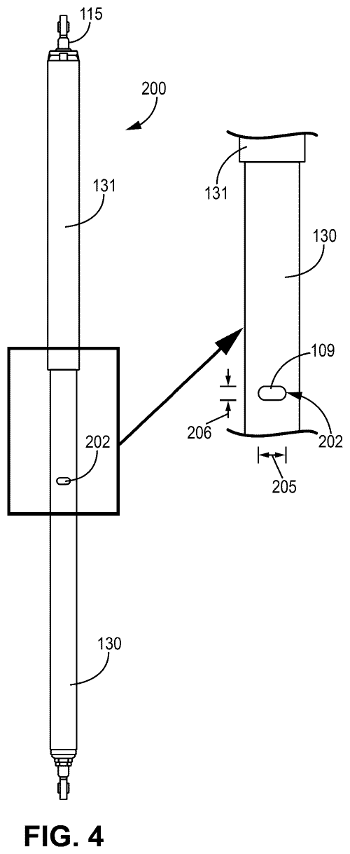

FIG. 4 illustrates an elevational view of another embodiment of a strut 200. The strut 200 can be similar to, or the same as, the strut 100 previously disclosed herein except that the strut 200 can have a different embodiment of the oil sight gauge. In particular, as shown at FIG. 4, oil sight gauge 202 included at strut 200 can have a different geometry than the oil sight gauge 102 shown at FIGS. 3A and 3B. For instance, the oil sight gauge 202 at the strut 200 can be configured as a transparent horizontal slit at the inner strut tube 130 having a width 205, in a direction transverse to the longitudinal axis of the strut 200, that is greater than a length 206, in a direction parallel to the longitudinal axis of the strut 200. The oil sight gauge 202 can be located at a position along the length of the inner strut tube 130 corresponding to an operational oil volume within the strut 200 when the strut is at an extended position resulting from the torque tube and upper damper mount being at the predefined rotational position (e.g., sixty degree stowed predefined rotational position). As such, the oil sight gauge 202 as a transparent horizontal slit at the inner strut tube 130 and located at a position along the length of the inner strut tube 130 corresponding to an operational oil volume within the strut 200 when the strut is at an extended position resulting from the torque tube and upper damper mount being at the predefined rotational position can allow for quick and convenient visual assessment as to whether oil is seen though the sight gauge 202 as would be the case when the oil volume within the strut 200 is sufficient to meet an operational oil volume level.

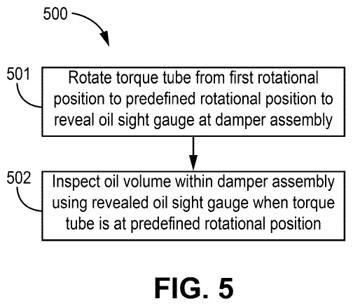

FIG. 5 is a flow diagram of an embodiment of a method 500 for inspecting an oil volume at a damper assembly at a solar tracker apparatus. In various embodiments, the method 500 can involve any one or more of the solar tracker and damper assembly features as disclosed previously herein.

At step 501, the method 500 includes rotating a torque tube of the solar tracker from a first rotational position to a predefined rotational position, which is different than the first rotational position, to reveal an oil sight gauge at the damper assembly. For instance, when the torque tube is at the first rotational position the oil sight gauge can be covered (e.g., covered by the outer strut tube), and when the torque tube is at the predefined rotational position the oil sight gauge can be uncovered (e.g., uncovered by the outer strut tube) to reveal the oil sight gauge.

In one such particular embodiment, the damper assembly can include a strut that has the oil sight gauge and is operably coupled to the torque tube such that rotating the torque tube from the first rotational position to the predefined rotational position to reveal the oil sight gauge includes effectuating a compression or an extension of the strut to uncover the oil sight gauge. For instance, when the torque tube is at the first rotational position, a strut rod of the strut can be extended out from the damper assembly a first distance that causes the oil sight gauge to be covered, and, when the torque tube is at the predefined rotational position, the strut rod can be extended out from the damper assembly a second distance, that is different than the first distance, that causes the oil sight gauge to be revealed and uncovered. As one specific such example where the strut includes an inner strut tube and an outer strut tube that is movable relative to the inner strut tube via the strut rod and includes the oil sight gauge located at the inner strut tube, when the torque tube is at the first rotational position the oil sight gauge can be covered by the outer strut tube, and when the torque tube is at the predefined rotational position the oil sight gauge can be uncovered by the outer strut tube.

The predefined rotational position to which the torque tube is rotated at step 501 can be useful in providing a common reference orientation of the strut at which to visually assess oil volume within the strut using the oil sight gauge. As one example, the predefined rotational position of the torque tube can correspond to a stowed solar tracker orientation. For instance, this predefined rotational position of the torque tube can be a sixty degrees stowed position of the torque tube, while the first rotational position of the torque tube, from which the torque tube is rotated to the predefined rotational position, can be any other rotational position of the torque tube ranging from zero degrees to less than sixty degrees.

At step 502, the method 500 includes, when the torque tube is at the predefined rotational position and the oil sight gauge is revealed, inspecting an oil volume within the damper assembly using the oil sight gauge. As one example, inspecting the oil volume within the damper assembly using the oil sight gauge can include determining that the damper assembly does not need maintenance when oil is visible through the oil sight gauge while the torque tube is at the predefined rotational position and the oil sight gauge is revealed. In another, additional example, inspecting the oil volume within the damper assembly using the oil sight gauge can further include determining that the damper assembly needs maintenance when oil is not visible through the oil sight gauge while the torque tube is at the predefined rotational position and the oil sight gauge is revealed.

In some examples, the method 500 can further include, for instance after inspecting the oil volume using the oil sight gauge at step 502, rotating the torque tube from the predefined rotational position, at which the inspection using the uncovered oil sight gauge occurs, to another different rotational position that causes the oil sight gauge to be covered (e.g., covered by the outer strut tube). The ability to cover the oil sight gauge when the torque tube is rotated outside of the predefined rotational position can be useful is protecting (e.g., shielding with the outer strut tube) the oil sight gauge in the field, such as from damage to the oil sight gauge and/or ingress of particulate.

Various examples have been described. These and other examples are within the scope of the following claims.

What is claimed is:

1. A damper assembly comprising:
an upper damper mount, the upper damper mount configured to operably couple to a torque tube of a solar tracker;
a lower damper mount, the lower damper mount configured to operably couple to a pier of the solar tracker; and
a strut, the strut configured to operably couple to the upper damper mount at a first end portion of the strut and to operably couple to the lower damper mount at a second, opposite end portion of the strut such that rotation of the upper damper mount effectuates a compression or an extension of the strut between the upper damper mount and the lower damper mount,
wherein the strut comprises an oil sight gauge located at a position along the strut such that the oil sight gauge is covered when the upper damper mount is at a first rotational position and uncovered when the upper damper mount is at a second, different rotational position.

2. The damper assembly of claim 1,
wherein the damper assembly is configured for use with a solar tracker such that the upper damper mount is configured to operably couple to a torque tube of the solar tracker and the lower damper mount is configured to operably couple to a pier of the solar tracker, and
wherein the oil sight gauge is located at a position along the strut such that the oil sight gauge is covered when the torque tube is at a first rotational position and uncovered when the torque tube is at a second, different rotational position.

3. The damper assembly of claim 2, wherein the second, different rotational position is a predefined rotational tilt position of the torque tube such that when the torque tube is at the predefined rotational tilt position the oil sight gauge is uncovered.

4. The damper assembly of claim 3, wherein the first rotational position is selected from group consisting of torque tube rotational tilt positions outside of the predefined rotational tilt position of the torque tube such that when the torque tube is at the torque tube rotational tilt positions outside of the predefined rotational tilt position the oil sight gauge is covered.

5. The damper assembly of claim 4, wherein the predefined rotational tilt position of the torque tube is a sixty degree stowed rotational position of the torque tube.

6. The damper assembly of claim 5, wherein the oil sight gauge comprises a transparent material at the strut.

7. The damper assembly of claim 6, wherein the oil sight gauge further comprises one or more oil level indicator markings adjacent to the transparent material.

8. The damper assembly of claim 1,
wherein the strut comprises an inner strut tube and an outer strut tube, the outer strut tube being movable relative to the inner strut tube,
wherein the oil sight gauge is located at a position along the inner strut tube such that the oil sight gauge is covered by the outer strut tube when the upper damper mount is at the first rotational position, and
wherein the oil sight gauge is located at a position along the inner strut tube such that the oil sight gauge is uncovered by the outer strut tube when the upper damper mount is at the second, different rotational position.

9. The damper assembly of claim 8, wherein, when the oil volume within the damper assembly is at an operational damper oil volume, the oil sight gauge is configured at the damper assembly such that the second rotational position of the upper damper mount corresponds to visibility of the operational damper oil volume within the damper assembly through the oil sight gauge.

10. The damper assembly of claim 9, wherein, when the oil level within the damper assembly is less than the operational damper oil volume, the oil sight gauge is configured at the damper assembly such that the second rotational position of the upper damper mount corresponds to a lack of visibility of the less than operational damper oil volume within the damper assembly through the oil sight gauge.

11. The damper assembly of claim 8,
wherein the strut further comprises a strut rod that is coupled to the outer strut tube,
wherein the strut rod is configured to operably couple to the upper damper mount at the first end portion of the strut, and
wherein the strut rod is configured such that rotation of the upper damper mount from the first rotational position to the second, different rotational position causes the strut rod to move the outer strut tube relative to the inner strut tube to thereby uncover the oil sight gauge at the inner strut tube.

12. A method for inspecting an oil volume at a damper assembly at a solar tracker, the method comprising the steps of:
rotating a torque tube of the solar tracker from a first rotational position to a predefined rotational position, that is different than the first rotational position, to reveal an oil sight gauge at the damper assembly; and
when the torque tube is at the predefined rotational position and the oil sight gauge is revealed, inspecting an oil volume within the damper assembly using the oil sight gauge.

13. The method of claim 12,
wherein when the torque tube is at the first rotational position the oil sight gauge is covered, and
wherein when the torque tube is at the predefined rotational position the oil sight gauge is uncovered to reveal the oil sight gauge.

14. The method of claim 13,
wherein the damper assembly comprises a strut that is operably coupled to the torque tube,
wherein the strut comprises the oil sight gauge, and
wherein rotating the torque tube from the first rotational position to the predefined rotational position to reveal the oil sight gauge comprises effectuating a compression or an extension of the strut to uncover the oil sight gauge.

15. The method of claim 14,
wherein when the torque tube is at the first rotational position a strut rod of the strut is extended out from the damper assembly a first distance that causes the oil sight gauge to be covered, and
wherein when the torque tube is at the predefined rotational position the strut rod is extended out from the damper assembly a second distance, that is different than the first distance, that causes the oil sight gauge to be revealed and uncovered.

16. The method of claim 15,
wherein the strut further comprises an inner strut tube and an outer strut tube, the outer strut tube being movable relative to the inner strut tube via the strut rod, and the oil sight gauge located at the inner strut tube,
wherein when the torque tube is at the first rotational position the oil sight gauge is covered by the outer strut tube, and
wherein when the torque tube is at the predefined rotational position the oil sight gauge is uncovered by the outer strut tube.

17. The method of claim 13, wherein the predefined rotational position of the torque tube corresponds to a stowed solar tracker orientation.

18. The method of claim 13, wherein the predefined rotational position of the torque tube is a sixty degrees stowed position, and wherein the first rotational position of the torque tube is any other rotational position of the torque tube ranging from zero degrees to less than sixty degrees.

19. The method of claim 12, wherein inspecting the oil volume within the damper assembly using the oil sight gauge comprises determining that the damper assembly does not need maintenance when oil is visible through the oil sight gauge while the torque tube is at the predefined rotational position and the oil sight gauge is revealed.

20. The method of claim 19, wherein inspecting the oil volume within the damper assembly using the oil sight gauge further comprises determining that the damper assembly needs maintenance when oil is not visible through the oil sight gauge while the torque tube is at the predefined rotational position and the oil sight gauge is revealed.
